(19) United States
(12) Patent Application Publication
(10) Pub. No.: US 2012/0266476 A1
(43) Pub. Date: Oct. 25, 2012

(54) TEST DEVICE FOR CHECKING POSITION OF HOLE

(75) Inventor: BING-JUN ZHANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/193,599

(22) Filed: Jul. 28, 2011

(30) Foreign Application Priority Data
Apr. 21, 2011 (CN) 201110100903.3

(51) Int. Cl. G01B 3/00

(52) U.S. Cl. 33/558.01

(57) ABSTRACT

Provided is a test device for checking whether the position of a first circular through hole defined in a workpiece meets a tolerance requirement. The test device includes a base, a positioning block, a test pin, a floating support block, and a standard design part. The positioning block is mounted on the base and positions the workpiece. The test pin includes a cylindrical rod capped with a conical part. The floating support block is coupled to the base and supports the test pin. A central axis of the test pin is coincident with a central axis of the first circular through hole. The standard design part is mounted on the base and defines a second circular through hole. If the cylindrical rod can insert into the second circular through hole, the positioning of the first circular through hole meets the tolerance requirement.

### BACKGROUND

1. Technical Field

The present disclosure relates to a test device for checking the position of a hole in a workpiece.

2. Description of Related Art

In manufacturing, it is necessary to test the position of holes formed in workpieces such as metal plates. Usually, a vernier caliper is used to test the positioning of the holes, however, the vernier caliper is unwieldy to use and usually needs preliminary adjustment before it can be used.

Therefore, it is desirable to provide a test device which can overcome the above-mentioned limitations.

### BRIEF DESCRIPTION OF THE DRAWINGS

FIG. 1 is an isometric view of a test device for checking the position of a hole, according to an exemplary embodiment.

FIG. 2 is a different isometric view of the test device of FIG. 1.

FIG. 3 is an exploded isometric view of the test device of FIG. 1.

FIG. 4 is a cross-sectional view of the test device of FIG. 1 taken along the line IV-IV.

FIG. 5 is an isometric view of a workpiece.

FIG. 6 is a side view of the workpiece of FIG. 5.

FIG. 7 is an isometric view of the test device of FIG. 1 being used with the workpiece of FIG. 5.

FIG. 8 is a different isometric view of the test device of FIG. 1 being used with the workpiece of FIG. 5.

FIG. 9 is a top view of the test device of FIG. 1 being used with the workpiece of FIG. 5.

FIG. 10 is a side view of the test device of FIG. 1 coupled with the workpiece of FIG. 5.

FIG. 11 is a different top view of the test device of FIG. 1 coupled with the workpiece of FIG. 5.

### DETAILED DESCRIPTION

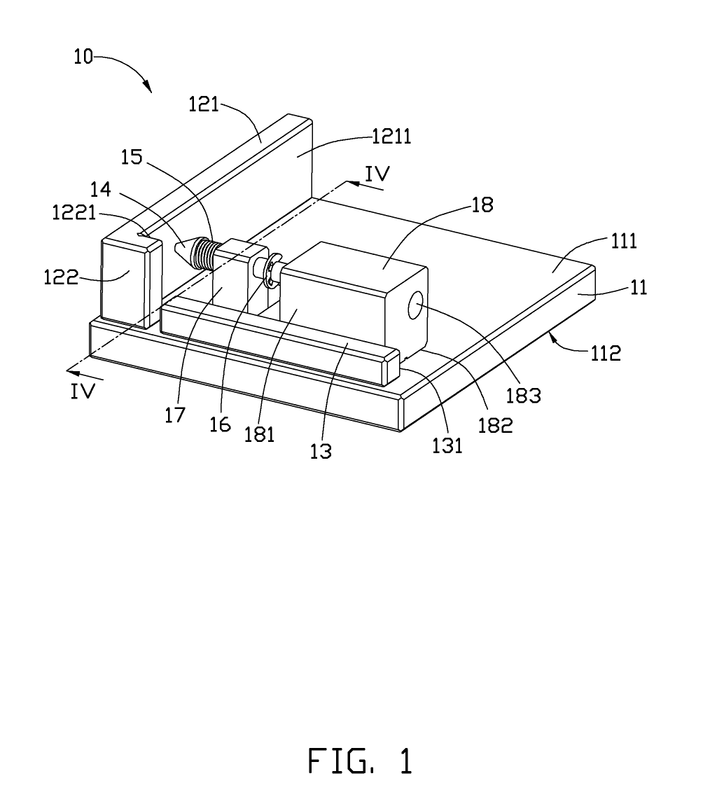

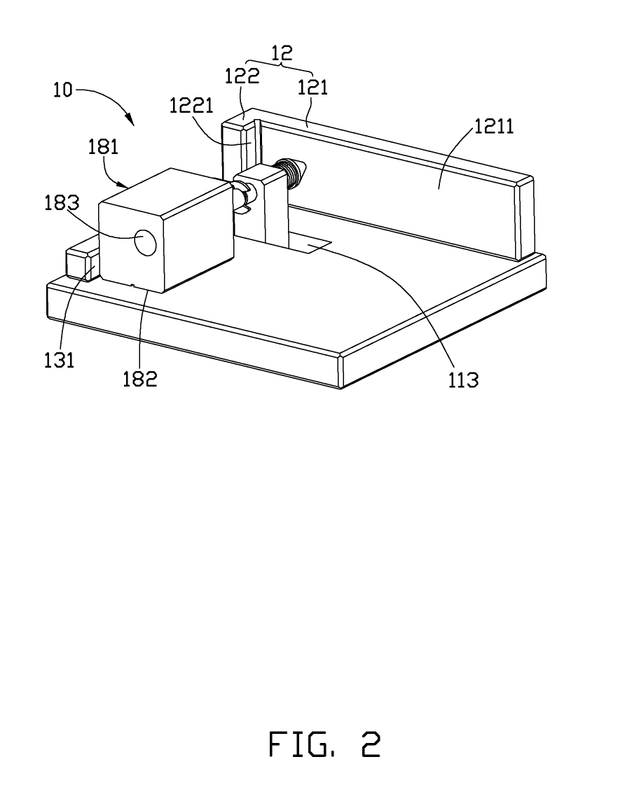

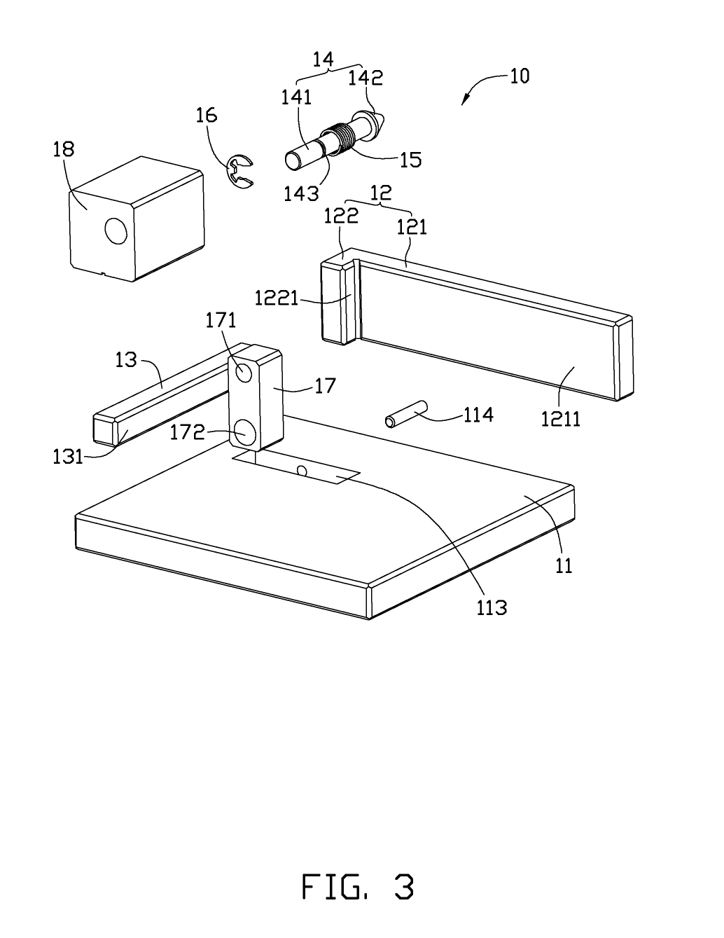

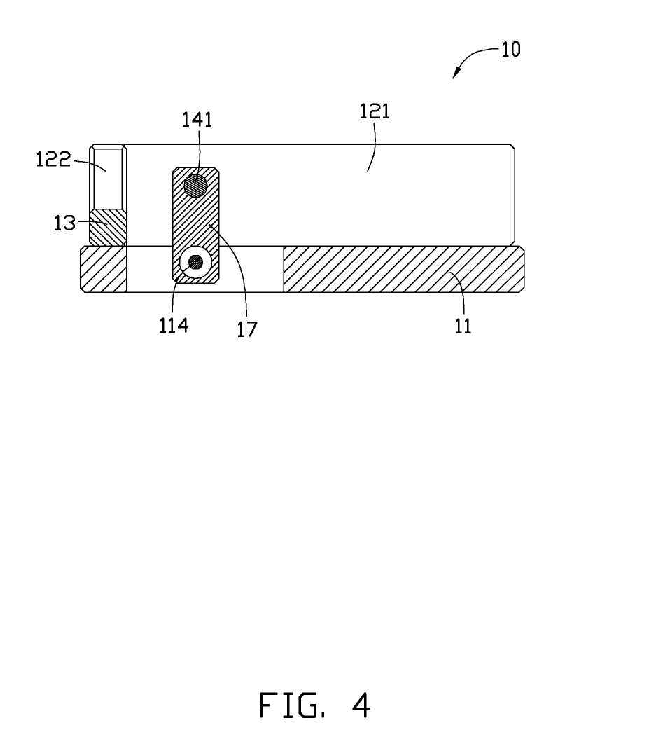

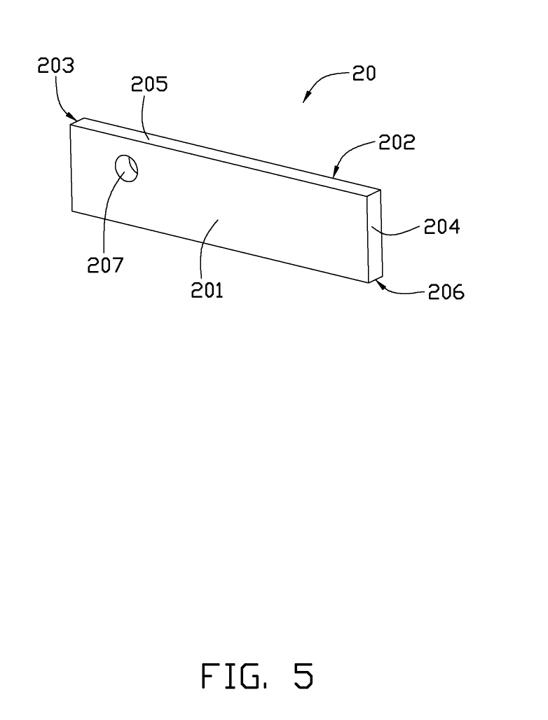

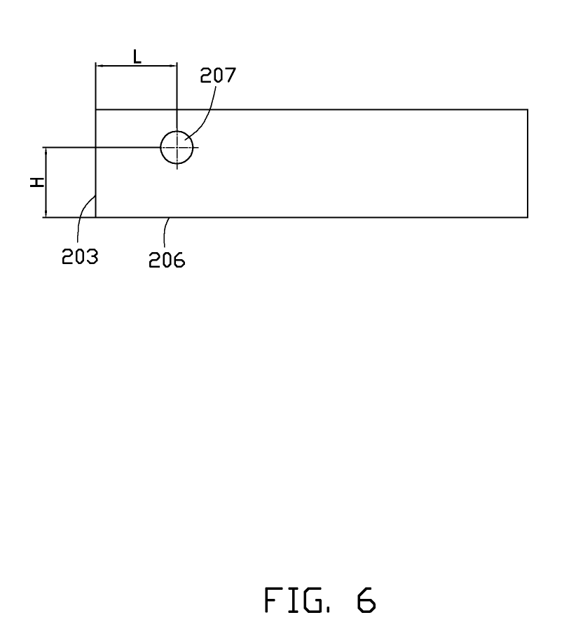

Referring to FIGS. 1-4, a test device 10 for checking the position of a hole in a workpiece 20 (see FIGS. 5-6) is shown. The test device 10 includes a base 11, a first positioning block 12, a second positioning block 13, a test pin 14, a spring 15, a circlip (clasp) 16, a floating support block 17, and a standard design part 18.

Referring to FIGS. 5-6, the workpiece 20 is a cuboid, and includes a first surface 201, a second surface 202 opposite to the first surface 201, a first reference surface 203, a third surface 204 opposite to the first reference surface 203, a fourth surface 205 connecting between the first reference surface 203 and the third surface 204, and a second reference surface 206 opposite to the fourth surface 205. The workpiece 20 defines a first circular through hole 207 extending from the first surface 201 straight through to the second surface 202. That is, a central axis of the first circular through hole 207 is parallel to the first reference surface 203 and the second reference surface 206, respectively. For a workpiece designed and manufactured to a certain standard (standard workpiece 20), the design distance between the central axis of the first circular through hole 207 and the first reference surface 203 is L, the design distance between the central axis of the first circular through hole 207 and the second reference surface 206 is H, the positional tolerances of the central axis of the first circular through hole 207 relative to the first reference surface 203 and the second reference surface 206 are both φx. For a workpiece 20 in practice, the central axis of the first circular through hole 207 may move due to errors in the manufacturing process. Accordingly, the test device 10 is used to test whether the position of the central axis of the first circular through hole 307 is within the positional and allowable tolerances.

The base 11 is a flat cuboid. The base 11 includes a top surface 111, a bottom surface 112, and a rectangular opening 113 extending from the top surface 111 to the bottom surface 112. The opening 113 is configured for holding the floating support block 17 movably captive. The top surface 111 is flat.

The first positioning block 12 is L-shaped, and includes a first positioning part 121 and a second positioning part 122. The first positioning part 121 includes a first positioning surface 1211 substantially perpendicular to the top surface 111, the second positioning part 122 includes a second positioning surface 1221 substantially perpendicular to the top surface 111, and the first positioning surface 1211 is substantially perpendicular to the second positioning surface 1221. The first positioning surface 1211 abuts the second surface 202 of the workpiece 20, and the second positioning surface 1221 abuts the first reference surface 203. The first positioning block 12 may be mounted on the top surface 111 of the base 11 by means of screws.

The second positioning block 13 is a bar which is square in cross section. The second positioning block 13 includes a guide surface 131 substantially perpendicular to the top surface 111. The guide surface 131 is coplanar with the second positioning surface 1221. The second positioning block 13 may be mounted on the base 11 by means of screws.

The test pin 14 includes a cylindrical rod 141 capped with a conical part 142. The cylindrical rod 141 is coaxial with the conical part 142. The base diameter of the conical part 142 is larger than that of the first circular through hole 207. The diameter of the cylindrical rod 141 is Dl. The conical part 142 explores the first circular through hole 207.

The floating support block 17 supports the test pin 14 so that the central axis of the test pin 14 coincides with that of the first circular through hole 207. The floating support block 17 is substantially a cuboid, and defines a second circular through hole 171 and a third circular through hole 172. The second circular through hole 171 is a cylindrical container for the cylindrical rod 141. One end of the floating support block 17 with the third circular through hole 172 is received in the opening 113. A pin 114 is inserted into the opening 113 and through the third circular through hole 172 from a side surface of the base 11, so that the floating support block 17 is held movably captive in the base 11. The diameter of the third circular through hole 172 is greater than that of the pin 114. The difference between the diameter of the third circular through hole 172 and that of the pin 114 is greater than φx, so that the floating support block 17 is capable of small movements on a single plane relative to the pin 114.

The fit between the floating support block 17 and the opening 113 is a tight clearance fit, preventing any movement by the floating support block 17 along the axis of the pin 114. A line connecting a center of the second circular through hole 171 and a center of the third circular through hole 172 is parallel to a surface of the floating support block 17.

A spring 15 is coiled around the cylindrical rod 141, and abuts the base of the conical part 142. The spring 15 urges the conical part 142 into the first circular through hole 207 of the workpiece 20. A circular groove 143 is defined around the circumference of the cylindrical rod 141 proximate to the uncapped end, to receive the circlip 16, such that the spring 15 is captive between the conical part 142 and the floating support block 17.

The standard design part 18 is cuboid, and includes a third reference surface 181 and a fourth reference surface 182 substantially perpendicular to the third reference surface 181. The standard design part 18 defines a fourth circular through hole 183, and the central axis of the fourth circular through hole 183 is parallel to the third reference surface 181 and the fourth reference surface 182. The diameter of the fourth circular through hole 183 is D2, the actual distance between the central axis of the fourth circular through hole 183 and the third reference surface 181 is L, and the actual distance between the central axis of the fourth circular through hole 183 and the fourth reference surface 1813 is H. The diameter of the fourth circular through hole 183 is D2, where D2=D1+φx.

The fourth reference surface 182 abuts the top surface 111 of the base 11. In complete and continuous contact with the guide surface 131, the standard design part 18 is slidable in a direction parallel to the test pin 14 on the top surface 111. In the present embodiment, the standard design part 18 is driven to slide manually. In other embodiments, the standard design part 18 may be driven to slide by other means, for example, a linear motor. If the smooth ingress of the cylindrical rod 141 into the fourth circular through hole 183 can occur, the position of the first through hole 207 does meet the design requirement; if the cylindrical rod 141 cannot be inserted into the fourth through hole 183, the position of the first through hole 207 fails to meet the designed requirement.

A test process using the test device 10 will be described below.

First, the test pin 14 is pulled along the central axis of the test pin 14 in a direction away from the first positioning block 12 to compress the spring 15.

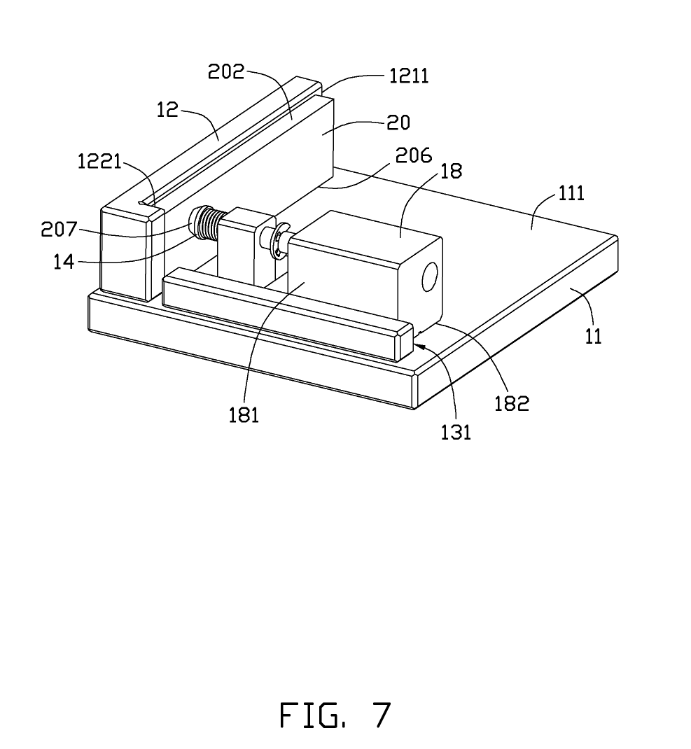

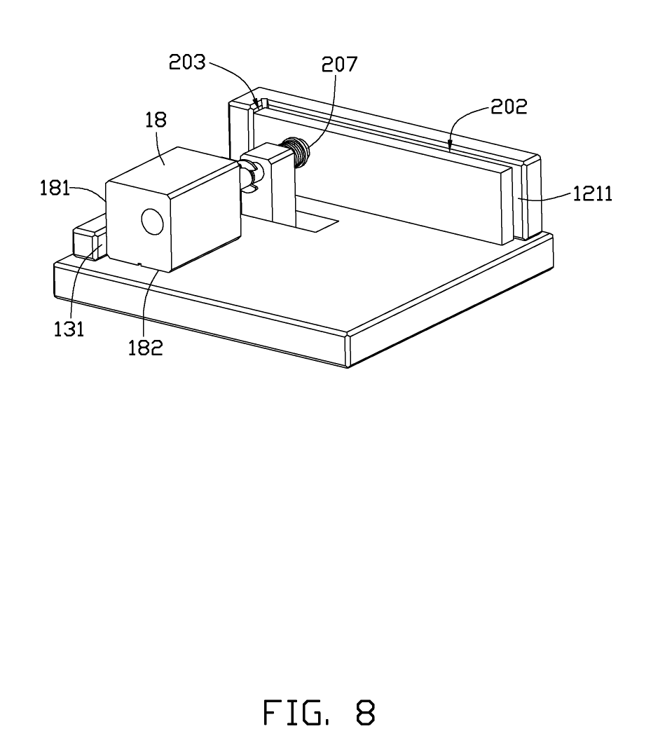

Second, the workpiece 20 is placed between the first positioning block 12 and the test pin 14, so that the second reference surface 206 abuts the top surface 111, and the first reference surface 203 abuts the second positioning surface 1221, also referring to FIGS. 7-8.

Third, the test pin 14 is released so that the conical part 142 attempts to insert itself into the first through hole 207 of the workpiece 20.

Fourth, the standard design part 18 is placed on the base 11, so that the fourth reference surface 182 abuts the top surface 111, and the third reference surface 181 abuts the guide surface 131.

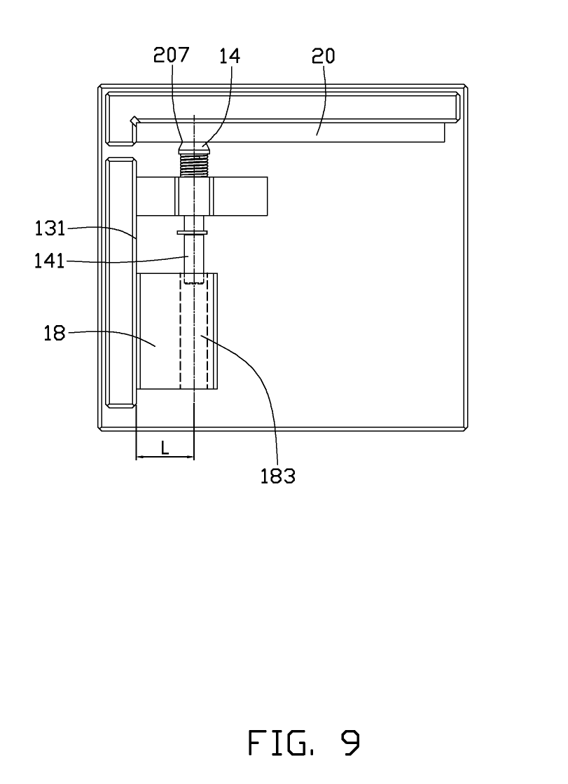

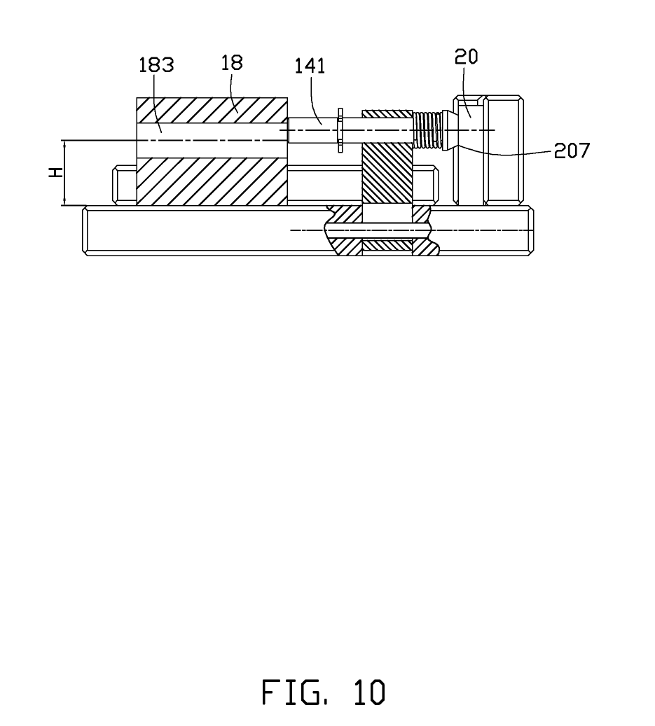

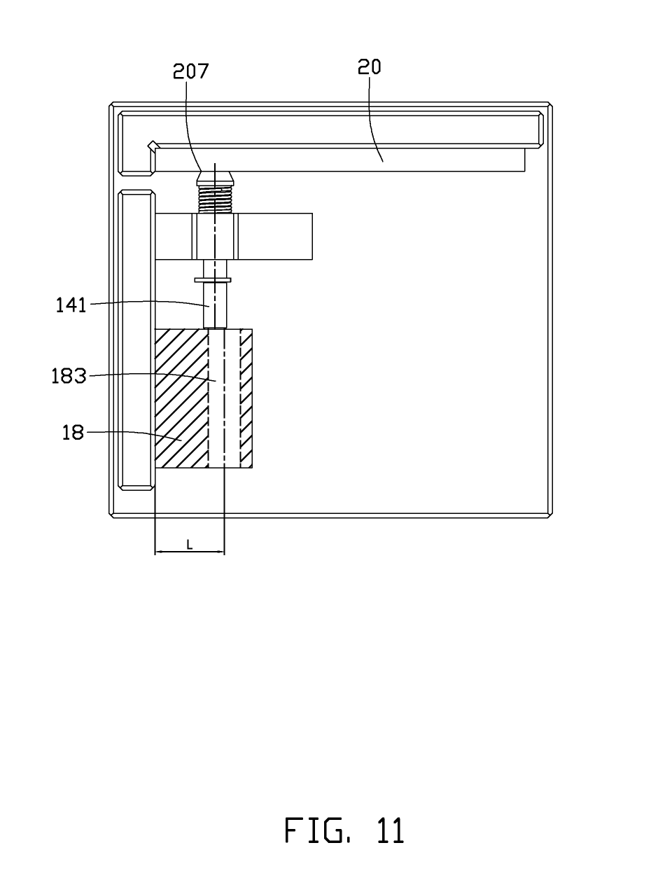

Fifth, the standard design part 18 is driven to slide towards the test pin 14 in such a manner that the third reference surface 181 maintains complete contact with the guide surface 131. If the cylindrical rod 141 can be accepted by the fourth through hole 183, referring to FIG. 9, the position of the first through hole 207 of the workpiece 20 meets the design requirement (see FIGS. 5-6). If the cylindrical rod 141 cannot be inserted into the fourth through hole 183 (these alternative situations may occur, as shown in FIGS. 10-11), the position of the first through hole 207 of the workpiece 20 fails to meet the design requirement (see FIGS. 5-6).

While various embodiments have been described, it is to be understood that the disclosure is not limited thereto. On the contrary, various modifications and similar arrangements (as would be apparent to those skilled in the art), are also intended to be covered. Therefore, the scope of the appended claims should be accorded the broadest interpretation so as to encompass all such modifications and similar arrangements.

What is claimed is:

1. A test device for checking whether a position of a first circular through hole of a workpiece meets a tolerance requirement, the workpiece comprising a first reference surface, and a second reference surface, a central axis of the first circular through hole being parallel to the first reference surface and the second reference surface, a design distance between the central axis of the first circular through hole and the first reference surface being L, a design distance between the central axis of the first circular through hole and the second reference surface being H, positional tolerances of the first circular through hole relative to the first reference surface and the second reference surface both being φx, the test device comprising:
a base, the base comprising a first flat surface for contacting the second reference surface;
a first positioning block mounted on the base, the first positioning block being configured for fixing the workpiece;
a test pin, the test pin comprising a cylindrical rod and a conical part, the cylindrical rod being connected to a bottom surface of the conical part, the cylindrical rod and the conical part being coaxial, a diameter of the bottom surface being greater than a diameter of the first circular through hole, a diameter of the cylindrical rod being Dl, the conical part being configured for inserting into the first circular through hole;
a floating support block coupled to the base, the floating support block being configured for supporting the test pin so that a central axis of the test pin is coincident with the central axis of the first circular through hole; and
a standard design part positioned on the base, the standard design part comprising a third reference surface and a fourth reference surface perpendicular to the third reference surface, and defining a second circular through hole, a central axis of the second circular through hole being parallel to the third reference surface and the fourth reference surface, an actual distance between the central axis of the second circular through hole and the third reference surface being L, an actual distance between the central axis of the second circular through hole and the fourth reference surface being H, a diameter of the second circular through hole being D2, wherein D2=D1+φx, the fourth reference surface abuts the first flat surface of the base, the standard design part is capable of sliding on the first flat surface in such a manner that the third reference surface is kept coplanar with the first reference surface.

2. The test device of claim 1, wherein the first flat surface defines an opening, the test device further comprises a pin, the floating support block defines a third circular through hole and a fourth circular through hole, the cylindrical rod passes through the third circular through hole, one end of the floating support block is received in the opening, the pin inserts into the opening and the fourth circular through hole so that the floating support block is movably captive in the opening, a diameter of the fourth circular through hole is greater than a diameter of the pin, and a difference between the diameter of the fourth circular through hole and the diameter of the pin is greater than σx.

3. The test device of claim 2, wherein the cylindrical rod defines a circular groove around a circumference thereof, the test device further comprises a circlip and a spring coiled around the cylindrical rod, the circlip engages in the circular groove so that the spring is captive between the conical part and the floating support block, and the spring is configured for driving the conical part to insert into the first circular through hole by exerting an elastic force on the conical part.

4. The test device of claim 1, further comprising a second positioning block mounted on the base, wherein the second positioning block comprises a guide surface for being coplanar with the first reference surface, the third reference surface abuts the guide surface.

5. The test device of claim 4, wherein the second positioning block is a bar, which is square in cross-section.

6. The test device of claim 1, wherein the first positioning block is L-shaped, and comprises a first positioning part and a second positioning part connected to the first positioning part, the first positioning part comprises a first positioning surface substantially perpendicular to the first flat surface, the second positioning part comprises a second positioning surface substantially perpendicular to the first flat surface, the first positioning surface is substantially perpendicular to the second positioning surface, the second positioning surface is configured for abutting the first reference surface, and the first positioning surface is configured for abutting the workpiece.

7. The test device of claim 1, wherein the workpiece is cuboid.

8. The test device of claim 1, wherein the standard design part is cuboid.
